(19) United States
(12) Patent Application Publication
(10) Pub. No.: US 2007/0011185 A1
(43) Pub. Date: Jan. 11, 2007

(54) Apparatus and method for data analysis

(76) Inventor: Robinson John, Berkshire (GB)

Correspondence Address: Ober Kaler;c/o Royal W. Craig, 120 East Baltimore Street, Suite 153, Baltimore, MD, 21202, US

(21) Appl. No.: 10/569,988

(22) PCT Filed: Aug. 26, 2004
(86) PCT No.: PCT/GB04/03651

§ 371 Date: Feb. 28, 2006

(30) Foreign Application Priority Data
Aug. 29, 2003 (GB) 0320220.7

(51) Int. Cl. G06F 7/00

(52) U.S. Cl. 707/102

(57) ABSTRACT

Survey and analysis apparatus comprises an inquisitorial server (10) fed questions from a question source (12), adducing survey data from selected users at user terminals (16) on the Internet (14), and providing data to an analyser (18) giving results to a responding server (20) accessible to a sponsor at a sponsor terminal (22) and to any other nominated recipient. Questions comprise plural statements (52) in sets (50) one of which is to be selected by a respondent per set (50). Each statement (52) has a poly dimensional weighting ABCDEFG. Questions can be set by a sponsor (22) or can be from a predetermined set 38. When analysed (18), the poly dimensional weighting ABCDEFG for each selected statement (52) are determined and aggregated. Graphical 2 or 3 dimensional display can include a selectable number of represented dimensions; a radius variation for a results cloud (80); a selectable result cloud colouration; a trend arrow added to a result cloud (80); a trend arrow added to a result point; a combined result statement; a deviation line (82); and a selectable number of axes (86). Automatic reports are generated by each range (94) for each dimension ABCDEFG being allocated a result statement (92), the selected range being chosen by aggregation an statistical analysis. Reports can comprise analysis statements (120), diagnosis statements (126), and advice statements (130) assembled into a humanly readable report (122).

The present invention relates to a method and apparatus for data analysis and for the presentation of results in a humanly interpretable form.

Previous solutions to analysis of data were more concerned with the problem of gathering generic data, and not with the collection of data where the data is requested and collected in a humanly meaningful form. The present invention seeks to provide a method and apparatus for collecting data where the data collected is presented to each provider of that data in a manner relating to human opinion and experience and where the data collected relates to human opinion and experience.

Examples of prior art solutions are to be found in French patent application FR 2775820 “Remote Analysis of the Profile of Persons Assessed for their Knowledge of Opinion Survey Data”, European patent application EP 1115073 “Method for Conducting Online Survey” and United States International Patent Application US 2002 065709 “System for Analysing Results of an Employee Survey to Determine Effective Areas of Organisational Improvement”.

Equally, earlier solutions to the analysis of data were more directed towards statistical analysis, or simple representation of results. The present invention seeks to provide a method and apparatus whereby collected data can be converted into forms which are in a readily humanly interpretable form and which can, simply, form the basis of decisions which are based upon criteria relating to human experience and life.

Another problem with prior methods of data gathering and analysis relates to the limited scope of data which can be gathered and analysed. Data and statistics was largely limited to numerical or simple mathematical data. A typical prior art data collection might ask a respondent to answer questions such as “how many times a week do you buy a newspaper?, tick the appropriate numeric box” or “how many children do you have at school age?”. By contrast, the present invention seeks to provide a method and apparatus whereby data of any sort can be analysed, where that data can reach into any and all realms of human opinion, experience and endeavour, and where that data can include all forms of the most concrete or abstract verbal or ideological expression and nuance. The present invention also seeks to provide a method and apparatus whereby such data can be analysed into similar form, suitable for real and meaningful interpretation, in the “real world”, by individuals or organisations, to assist in the achieving of aims or insights.

Prior art solutions are directed towards answering specific questions in a specific way. This limited the scope of the prior art solutions. By contrast, the present invention seeks to provide a generic tool, a method and apparatus where the question is “whatever you might wish the question to be”, where the analysis is done in any manner that is desired, and where the organisation and presentation of results can be directed towards any objective.

The present invention further seeks to provide a method and apparatus where the presented results can be further analysed to provide suggested alterations which can be made to move the loci of the first analysis towards a desired target locus or loci.

According to a first aspect, the present invention consists in an apparatus for collecting and analysing survey data, said apparatus comprising: means to store a plurality of selectable statements in a plurality of sets; means to associate, with each statement in each set, a poly-dimensional score; means to accept that statement which is selected in each set as the result for that set and to accept the respective poly-dimensional score as the score for that set; means to process and aggregate the poly-dimensional scores; and means graphically to display the processed and aggregated poly-dimensional scores as the results of the survey.

According to a second aspect, the present invention consists in a method for collecting and analysing survey data, said method including the steps of: storing a plurality of selectable statements in a plurality of sets; associating, with each statement in each set, a poly-dimensional score; accepting that statement which is selected in each set as the result for that set and accepting the respective poly-dimensional score as the score for that set; processing and aggregating the poly-dimensional scores; and graphically displaying the processed and aggregated poly-dimensional scores as the results of the survey.

According to a third aspect, the present invention consists in an apparatus for analysing survey data, where said survey data comprises a plurality of selectable statements, each statement having associated therewith a poly-dimensional score relating to a plurality of result dimensions, said apparatus comprising: a result statement store for storing a result statement fragment for each of a plurality of ranges for each of the result dimensions; means to process and aggregate the scores for each result dimension; means, for each result dimension, to retrieve the appropriate result statement fragment for the processed and aggregated score for that result dimension; and conjunctive means to assemble the plurality of result statement fragments into one or more result statements, comprehensible in written language.

According to a fourth aspect, the present-invention consists in a method for analysing survey data, where said survey data comprises a plurality of selectable statements, each statement having associated therewith a poly-dimensional score relating to a plurality of result dimensions, said method including the steps of: storing, in a result statement store, a result statement fragment for each of a plurality of ranges for each of the result dimensions; processing and aggregating the scores for the selected statements for each result dimension; retrieving, for each result dimension, the appropriate result statement fragment for the processed and aggregated score for that result dimension; and assembling the plurality of result statement fragments into one or more result statements, comprehensible in written language.

The invention further provides that the graphical display can be in a selectable number of represented dimensions, and/or can comprise radius variation for a results cloud, and/or can comprise result cloud colouration, and/or can comprise trend arrows added to a result cloud or result point.

The invention further provides that the axes of the represented dimensions can be a selectable combination of the result dimensions.

The invention further provides that the origin of the graphical display is selectable.

The invention further provides a method and apparatus for automated preparation of reports on the results of surveys.

The invention further provides that the automated report can be prepared by analysing the results from a survey group, using the analysis to place the results from the group into one of a plurality of categories, there being one set of report statements allocated to each category, and placing the selected set of report statements, appropriate to the category of the survey results, into a report.

The invention further provides that the report statements can include an analysis statement, a diagnosis statement, and an advice statement giving a recommendation.

The invention further provides that the data which is analysed can be gathered from the Internet, and/or an Intranet, and/or a digital television service.

The invention is further explained by the following exemplary description, coupled with the appended drawings, in which:

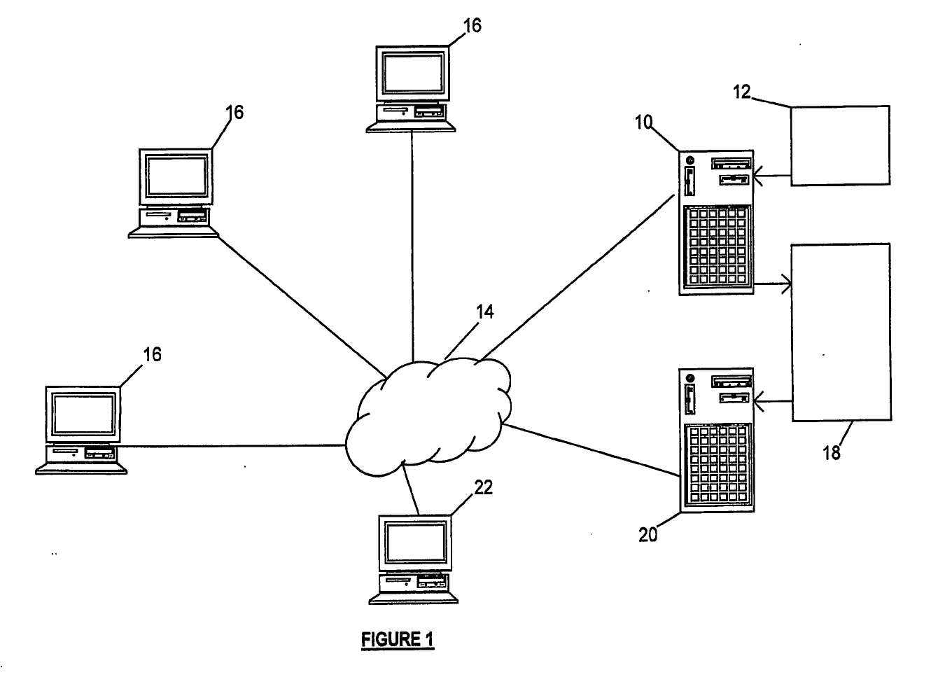

FIG. 1 is a schematic diagram showing an example of an environment within which the present invention is apt.

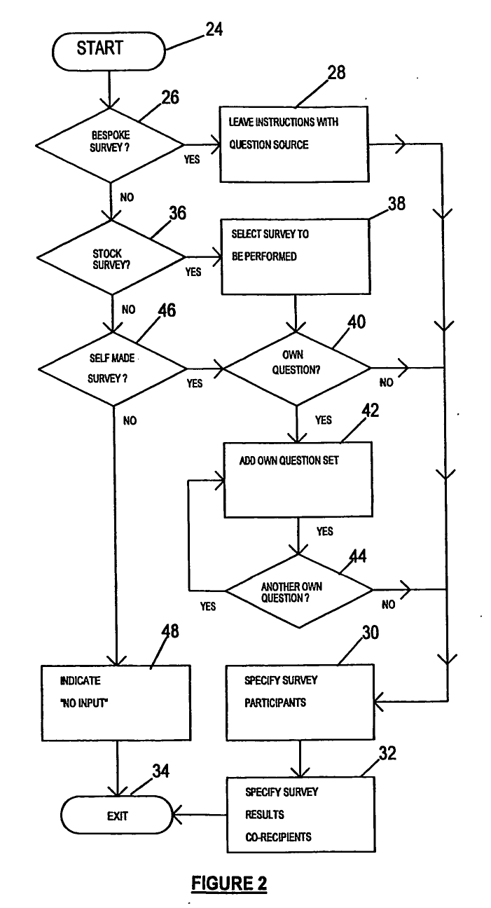

FIG. 2 is a flowchart showing the question formulation activity.

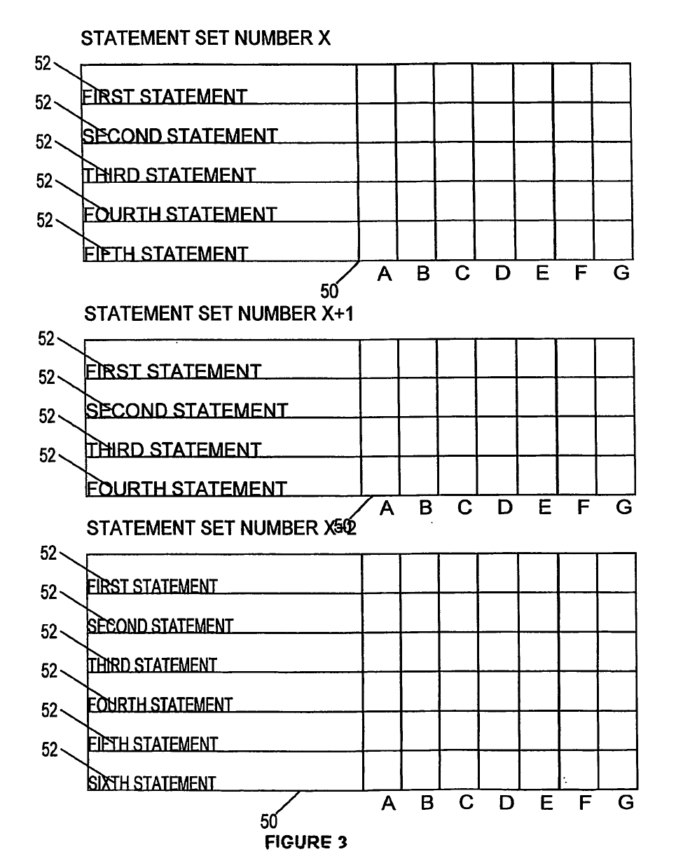

FIG. 3 is an example of a question store for a survey.

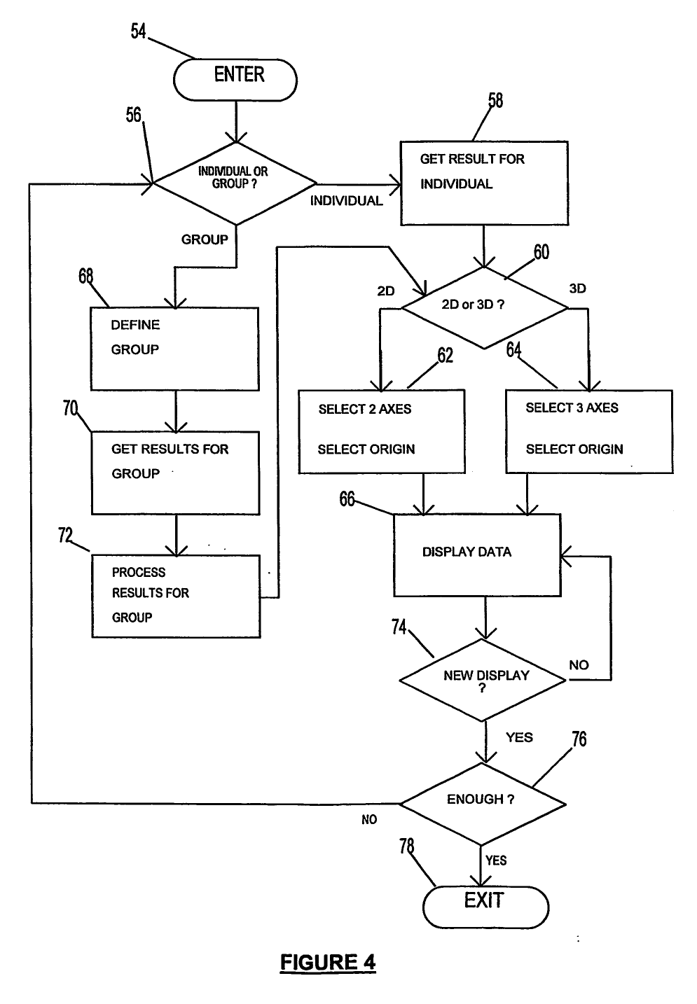

FIG. 4 is a flow chart showing one manner in which the results from a survey may be displayed.

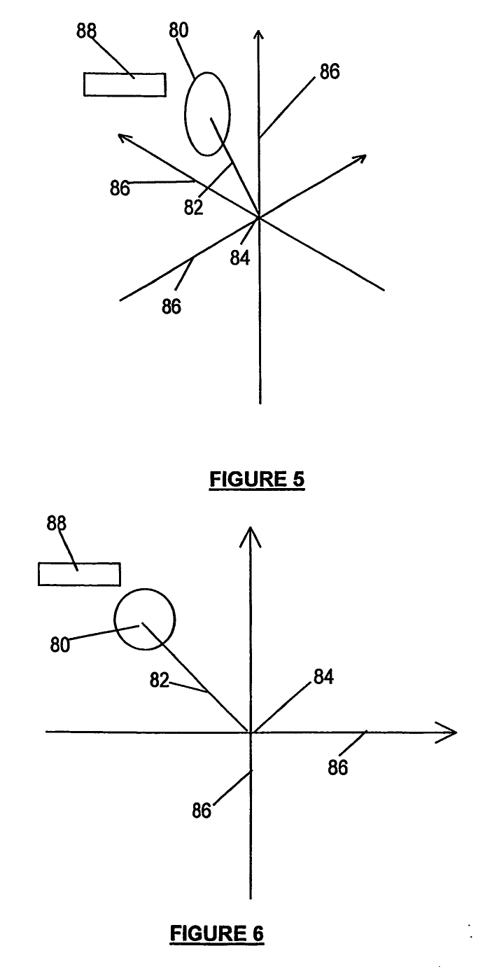

FIG. 5 shows one style of graphical display in which a three-dimensional display is presented.

FIG. 6 shows a two-dimensional version of the three-dimensional display shown in FIG. 5.

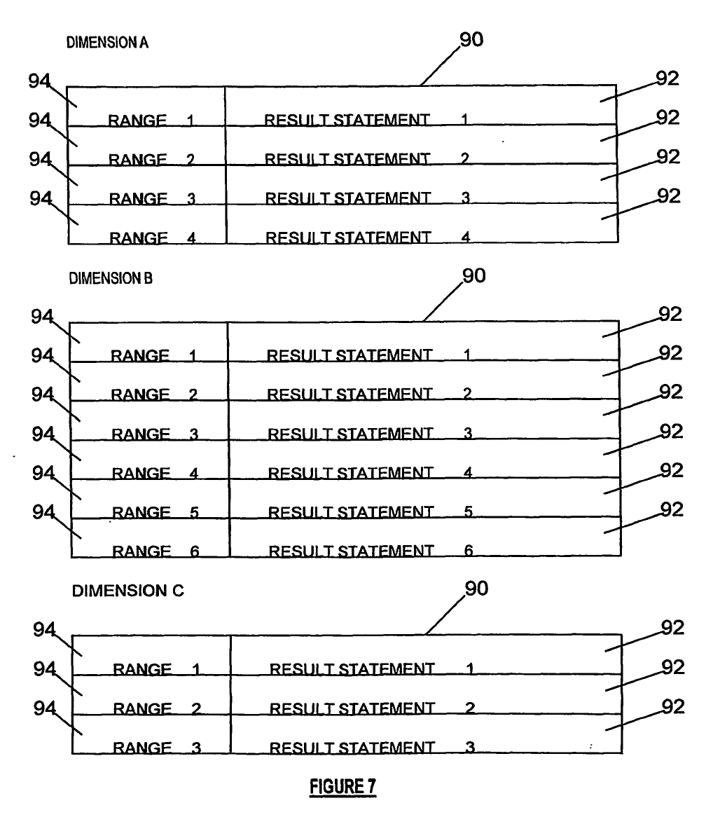

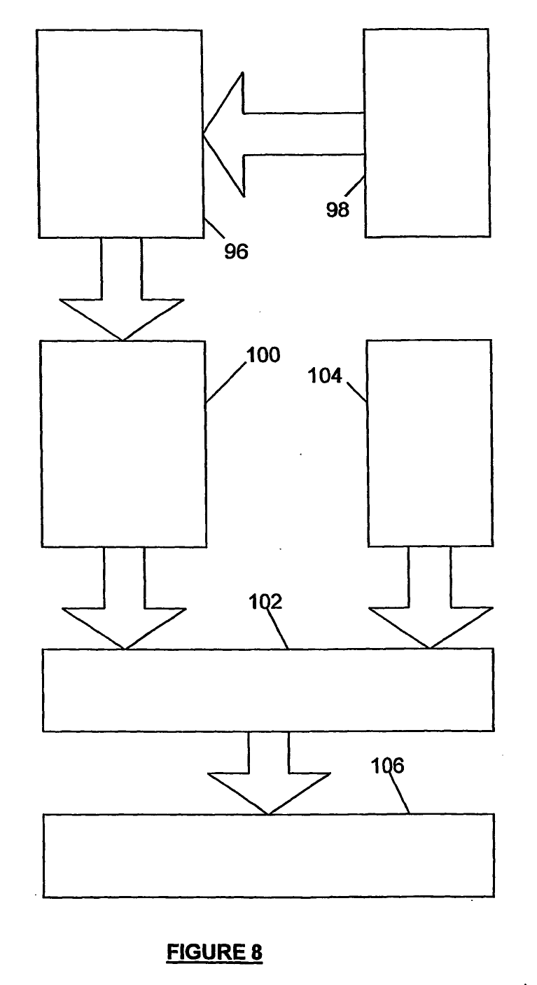

FIG. 7, is a memory chart, illustrating a first stage in the formulation of a combined result statement.

And

FIG. 8 is a block schematic diagram of one mechanism which can be employed to form the combined result statement.

Attention is drawn to FIG. 1, showing an example of an environment within which the present invention is apt.

An inquisitorial server 10 is fed questions to be asked in a survey by a question source 12. The question source 12 formulates the questions to be asked according to the present invention.

The inquisitorial server 10 can be contacted, through the Internet 14, by any one of a plurality of individuals each at their respective user terminal 16.

The individuals who may take part in the survey are pre-defined, so that only allowed individuals or members of a particular group, or particular groups, can participate. The identity of an individual and/or the membership of a particular group can be determined by passwords, the address of the respective user terminal 16, or any other data which can be used to identify an individual and can be sent to the inquisitorial server 10.

The inquisitorial server 10 checks the identity of the individual responding, and if the individual responding is a permitted individual, or a member of a permitted group for the particular survey, gathers the data from that individual. In this manner, the inquisitorial server gathers responses from the user terminals 16 and provides them as input to an analyser 18.

The inquisitorial server 12 and the analyser 18 keep a list of the permitted individuals together with the designation of the individuals so that division into groups can take place. For example, in a corporate survey, the individuals can come from different classifications of employee, customers, suppliers, and even members of the public at large. Within each designation can be further classifications, such as whether or not the individual is a key opinion former for that group classification, and so on. The list of users and designations are provided at the beginning of each survey, and can also be gleaned automatically from pre-prepared lists such as employee lists, customer lists and supplier lists.

The analyser 18 analyses the results, according to the present invention, and makes the results available to a responding server 20. The responding server 20 can be contacted through the Internet, by one or more result recipients each at a respective sponsor terminal 22 under the control of a sponsor for the particular survey. Once again, access to the results of the survey can be limited. The responding server 20 checks the identity of the alleged sponsor before permitting access.

The sponsor can also have elected various other individuals or groups who will have access to the survey results, and, after identity checking, the responding server 20 will allow access to them.

The arrangement of FIG. 1 shows questions being asked by result recipients 22 of users 16 using a question source 12 and an analyser 18.

The responding server and the inquisitorial server can be one and the same, in which case the results will be available only to the recipients 22.

At one extreme of operation, the analyser can analyse the data received from the users 16 only once. In another mode of operation, the analyser 18 can include and analyse data received from the users 16 since the last analysis, this being performed at fixed intervals.

At the other extreme of operation, the analyser 18 can include and analyse data received from the users 16 since the last analysis when required by a recipient 22. At the other extreme of operation, the analyser 18 can perform an analysis at each instance of new data being received from a user 16.

The analyser 18 presents results to the sponsors 22 or to their elected co-recipients through the responding server. It is a preferred feature of the present invention that results are only made available to the sponsor or co-recipients when more than predetermined sets of data have been collected from individuals at the user terminals 16.

The question source 12, in formulating the questions for the inquisitorial server 10, takes account of the intended information type that the recipient 22 desires.

In a first style of operation, the nature of the questions posed will be questions posed by the recipient 22 themselves, and to that end the recipient 22 will be in communication with the question source 18.

In a second style of operation, the recipient 22 can indicate to the question source 18 the general area of one or more of the natures of responses required, and the question source 18 can use stock questions to formulate actual questions to be provided to the inquisitorial server 10.

In another style of operation, a mixture of the first two styles of operation can be adopted.

As will become apparent from the subsequent description, each response to a question is also allocated a score, or more than one score, which is used for subsequent analysis. To this extent, the question source 12 must also communicate the elected score or scores for each response to the analyser 18. The question source 12 and the analyser can be incorporated together.

Communication between the recipient 22 and the question source can be by telephone or mail, in which case data is entered into the question source by hand or by human voice analysis. Communication between the question source 18 and the recipient can also be by the recipient 22 contacting the question source 18 directly via the Internet 14, in which case the recipient 22 can enter their input for the question source directly.

The invention can also cover other means of data gathering, using communication means such as Intranet, digital television or any other similar interactive display medium in any environment.

FIG. 1 merely illustrates one environment where the present invention can be used. FIG. 1 represents a preferred environment, but it is to be appreciated that the present invention can be employed on an Intranet, or in any environment or situation where questions are asked to gather data and the gathered data is analysed.

Attention is next drawn to FIG. 2, showing a flowchart of the question formulation activity.

The present invention is particularly apt for answering cultural or perceptual questions relating to an organisation, company, charity, political party, nation, sets of groups of individuals, to name but a few.

To establish the data for answering cultural or perceptual questions from the individuals, an individual is requested to respond to a sequential plurality of statement sets. Each statement set comprises two or more statements, and the individual is asked to indicate which statement most closely relates to the opinion held by that individual. In some sorts of survey, the individual may, in some statement sets, also have a “none of these” option. When the statement sets have all been answered, or a sufficiency of statement sets have been answered, the data can be accepted by the inquisitorial server 10.

From a start 24 a first test 26 seeks to know, from the sponsor 22 whether or not the sponsor wishes to conduct a bespoke survey, that is a survey particularly tailored to the sponsor's 22 unique and possibly unusual needs. If this is the case, a first operation 28 has the sponsor 22 leave a specification of his needs with the question source 12. A second operation 30 then has the sponsor 22 leave details, with the question source 12 of the individuals or groups of individuals to be questioned in the particular survey. Thereafter a third operation 32 has the question source 12 receive, from the sponsor 22, a list of those other individuals or groups of individuals which are to be allowed to receive the results of the survey. The third operation having been completed, control passes to exit 34.

If the first test 26 does not detect that the sponsor 22 requires a bespoke survey, control passes to a second test 36 which seeks to know, from the sponsor 22, whether the sponsor wishes to conduct a stock survey. A stock survey is a survey, of standard form, which the question source 12 would already have stored ready for use. If the second test 36 discovers that the sponsor 22 requires a stock survey, a fourth operation 38 has the sponsor 22 indicate to the question source 12 which stock survey is to be performed. Control is then passed to a third test 40 which seeks to know if the sponsor 22 wishes to add their own question or statement set. If not, control passes directly to the second operation 30. If the third test 40 detects that the sponsor 22 wishes to add his own question or statement set, the third test 40 passes control to a fifth operation 42 where the question source 12 receives, from the sponsor 22 a question or statement set to be added to the survey. Thereafter, a fourth test 44 seeks to know whether the sponsor 22 has a further question or statement set to be added to the survey. If so, control is returned to the fifth operation 42. If not, control is passed to the second operation 30.

If the second test 36 does not detect that the sponsor 22 requires a stock survey to be performed, control passes to a fifth test 46 which seeks to know, from the sponsor 22, whether or not the sponsor requires to make up his own survey. If this is the case, control is passed directly to the third test 40 seeking questions to be included in the survey. If not, control passes to a sixth operation 48 which indicates, from the sponsor 22 to the question source 12 that the communication, in this instance, has been abortive and that “no input” should be taken. Control then passes to exit 34.

It is to be emphasised that the activities of FIG. 2 are merely illustrative of the means whereby serving questions or statements can be created and merely illustrate one way, apt for use in the preferred embodiment of the present invention, in which such data may be gleaned and created.

Attention is drawn to FIG. 3 which shows the structure of statement sets 50 as they are used by the question source 12 and, later, analysed by the analyser 18.

Each statement set 50 comprises statements 52 with which the individual is to be asked to agree or disagree. As can be seen, statement sets 50 do not require to have the same number of statements. FIG. 3 shows, simply for example, an extract of three consecutive statement sets in a survey to be presented to be answered.

Each statement 52 has, associated with it, a series of weightings in a poly-dimensional space. If the individual selects a particular statement 52 in a particular statement set 50, the set of weightings for that particular statement 52 is taken as the individual's reply to that particular statement set 50. As can be seen, in the example given, a seven-dimensional analytical space has been allocated to the results from the exemplary survey. The columns marked A through G are, respectively, the dimensional weightings for each of the first through seventh dimensions which are to be used in the subsequent analysis by the analyser 18. This is only an example, and a particular survey could elect to have fewer or more dimensions for its analysis. Each of the boxes against each statement contains a number which can be positive, zero or negative to convey a meaning to the act of selecting that statement 52. Simply as an example of what the dimensions can imply, column A could relate to the apparent liking of the chief executive officer of a company. Column B could relate to the pay policy as perceived by the individual of that company. Column C could relate to the perceived ethical nature of the company. Column D could relate to the individual's perception of the quality of the products produced by the company. Column E could relate to the individual's perception of the price setting policy of the company. Column F could relate to the individual's perception of the company's business risk strategy. Column G could relate to the individual's perception of the company's growth strategy. These examples are merely examples to illustrate the sort of opinion which can be tested by a survey conducted according to the present invention.

Attention is next drawn to FIG. 4 which is a flow chart of one manner in which the results from a survey may be displayed.

From entry 54 a sixth test 56 seeks to learn from the sponsor 22 or from the authorised co-recipient whether or not it is desired to view and perhaps print the results of a survey for an individual, or for a group of individuals.

If the sixth test 56 learns that the results for an individual are to be displayed, a seventh operation 58 gets the results for the named individual. A seventh test 60 then seeks to learn whether display in two dimensions or three dimensions is desired. If display in two dimensions is desired, an eighth operation 62 has the sponsor 22 or the authorised co-recipient of survey results, select which two axes they wish, and also select the origin that they wish.

If the seventh test 60 detects that the sponsor 22 or the authorised co-recipient desires results in three dimensional form, a ninth operation 64 has the sponsor 22 or authorised co-recipient select which three axes are to be used for the display and also select the origin for the display.

The eighth operation 62 and the ninth operation 64 pass control to a tenth operation 66 which displays the data in the desired format.

Returning to the eighth operation 62 and to the ninth operation 64, because, as shown in FIG. 3, each selection can produce a poly-dimensional result it is important that the axes displayed are selected. Of course, if there are only two dimensions to the results, any display will be two-dimensional. If there are three dimensions to the result, any display will be, at most, three-dimensional having three axes. However, if there are more than the maximum number of axes in a display, it is necessary to select what the axes could be. Firstly, the selected axes can be one of the dimensions (A-G) shown in FIG. 3. The data for the other axes is simply not displayed. Alternatively, an axis can be selected which is a combination of two of the dimensions (A-G) shown in FIG. 3. In this case, the position along the selected axis can be achieved by simple addition, root mean square addition, or any other process which can be selected. As will be clear with reference to FIGS. 5 and 6, plural dimensional axes can also be represented by varying the size of the ‘results cloud’ and/or by attaching coloured arrows to show directional trends. The display of results in plural dimensions includes, but is not limited to, result point or cloud colouration, shape or radius of the result cloud or trend arrow indication attachment, or similar effects.

Also in the ninth operation 64 and the eighth operation 62 the origin must be selected. The origin of the graphic display is generally selected to coincide with the opinions expressed by an individual whose opinion counts, or to coincide with the result of surveying a key or influential group. For example, in a survey concerning the finances of a company, the chief financial officer will have been polled and his opinions would, if so desired, form the origin 84 for the graphical display. Alternatively, the entire board of a company may have been surveyed, and the resultant survey opinion taken as the origin 84. Equally, any other origin may be chosen for the graphical display.

If the sixth test 56 learns that the results for a group is required, an eleventh operation 68 receives a definition of which group is to be the subject of the graphical display. The group will define the results from a number of individuals. An individual can be in more than one group. For example, in a survey of a company, an individual may be a member of the accounting group, and may also be a member of a group defining middle managers and, indeed, could be a member of many other groups. The definition of the group received in the eleventh operation 68 determines whether the results from the individual will be included in the group results.

Thereafter, a twelfth operation 70 gets the stored results for the members of the group that has participated in the survey. A thirteenth operation 72 then processes the results for that group.

The processing of the results for a particular group undertaken by the thirteenth operation 72 can take various forms. As a first example, the data, as it was received, is simply provided and averaged. As another possibility, the median value for that data can be taken. As another option, the peak value for the data can be taken. These are only examples of the many ways in which the data from a group can be processed. The present invention encompasses processing group data in any way whatever.

The thirteenth operation 72, having processed the data, passes control to the seventh test 60 which begins the display type determination.

Returning to the tenth operation 66 which displays the data, if an eighth test 74 detects that a change in display is required, control is passed to a ninth test 76 which determines whether or not a further display is required. If no further display is required, the ninth test 76 passes control to exit 78. If the ninth test 76 detects that a further display is required, control passes back to the sixth test 56 which starts the display selection process all over again.

Attention is next drawn to FIG. 5 which shows one style in which a three-dimensional display can be presented. The results for an individual will be a point. However, for a group, a three-dimensional result cloud 80 is shown together, optionally, with a deviation line 82 which shows the distance and the direction of deviation of the result cloud 80 from origin 84 of the three chosen axes 86. A combined result statement 88 can also be provided adjacent to the result cloud 80 or the result point, whose construction is described hereafter, defining the beliefs and opinions of the individual or group displayed.

Attention is also drawn to FIG. 6 which shows a two-dimensional version of the three-dimensional display shown in FIG. 5.

Of course, in the display the results from more than one individual or group can simultaneously be displayed. Equally, the result cloud may be omitted and the median, average or other point of the results shown. The combined result statement 88 can be omitted from the graphical representations (FIGS. 5 and 6) and separately printed or displayed.

Attention is next drawn to FIG. 7, illustrating a first stage in the formulation of the combined result statement 88.

Each dimension (A-G) otherwise shown in FIG. 3, will, for any particular individual or group, whether before or after data processing of any kind, receive a unique result for that dimension. Each dimension, at the time of formulating the statement sets to be used, is also allocated a result statement table 90, each of which comprises a meaningful result statement 92 for each of a plurality of ranges 94 for the result for that dimension (A-G) which the individual or group actually scored.

For example, if the dimension A is concerned with the perception of the financial performance of a company, result statement 1 could be “Our company makes too little money”; result statement 2 could be “Our company makes enough money”; result statement 3 could be “Our company makes too much money” and result statement 4 could be “Our company makes excessively too much money”. The ranges are defined at the time of creating the statement sets.

Similar sets of ranges 94 and result statements 92 apply to each of the different dimensions. As can be seen in this example, the number of ranges and result statements can vary from dimension to dimension.

Attention is next drawn to FIG. 8 which is a block schematic diagram of one mechanism which can be employed to form the combined result statement 88 otherwise shown in FIGS. 5 and 6.

A dimensional statement store 96 receives the survey results from a survey result store 98 as addressing input. The dimensional statement store 96 produces, in response, the selected result statements 92 and provides them as a sequence of selected result statements 92 in the selected dimensional result statement store 100. The selected result statement store provides input to combined result statement logic 102 which also has access to data in a grammatical conjunction store 104 which contains a list of words suitable to combine the result statements 92 with one another as they exit from the selected result statement store. Each result statement 92 from the selected result statement store is inspected and, from a list, a suitable conjunctive word applied. If the combined result statement grows too long, let us say three or four result statements 92, the combined result statement logic 102 selects, from the grammatical conjunction store, the start of a new sentence so that the resulting combined result statement 88 can comprise two or more sentences.

The combined result statement logic 102 provides its humanly readable and meaningful language combined result statement to the combined result statement store 106 from whence the combined result statement may be variously displayed, included in documents or printed

The apparatus, here embodied as the analyser 18, also automatically assembles a report which contains humanly readable analysis elements, diagnosis elements and recommendation elements to be provided to the sponsor 22 or his designated co-recipients for each surveyed group.

An example of how this is done is described.

From entry a fourteenth operation selects the group of individuals from the survey to be reported upon. Thereafter a fifteenth operation gets the survey results for that group of individuals. Then, a sixteenth operation performs a statistical analysis on the selected survey results. The statistical analysis can include, but is not limited to, standard deviation, trend, number of influential people in the group and so on. The individual, skilled in the art, will be aware of many other ways in which the group data can be analysed.

The group data having been analysed by the sixteenth operation, a seventeenth operation determines into which of a plurality of categories the statistical analysis has placed the results from the selected group survey data.

The plurality of possible ranges of results were each pre-decided when the survey was specified, and each range was allocated a set of statements including an analysis statement, a diagnosis statement and an advice statement containing a recommendation for maintaining or remedying the situation. For example, if the data analysis from the sixteenth operation showed a standard deviation greater than 0.6, and a trend of less than 1.6, with more than three influential individuals in that group, then a particular category is defined and a particular analysis statement, a particular diagnosis statement and a particular advice statement are pre-defined for that range. As an example, for that range, the selected analysis statement might be that this particular group is deviant from the norm and slow to respond to influences, the diagnosis statement might be that this group requires special attention and the advice statement might be that training is required. Any other analysis statements, diagnosis statements and advice statements can be attached to any particular range as seems appropriate.

The results from the selected group having been categorised by the seventeenth operation, an eighteenth operation gets the appropriate selected analysis statement from an analysis statement store and inserts the selected analysis statement into a report along with an indication of which group is referred to.

Next, a nineteenth operation gets the selected diagnosis statement from a diagnosis statement store and inserts it into the report.

Finally, a twentieth operation gets the advice statement determined by the category found in the seventeenth operation from an advice statement store and also inserts it into the report. Thereafter, a tenth test looks to see if every group in the survey has been analysed. If there is not another group to analyse, control passes to exit. If there is still a group to be analysed for this particular survey, the tenth test passes control back to the fourteenth operation which selects the next group to be analysed.

Described has been one way in which a report is assembled. A report can comprise more or fewer types of statement, and the statements can be on different subjects.

The report can also contain details of the results obtained from every single individual and the categorisation of that individual for allocating that individual to a group or groups.

In this manner, an automatic, humanly readable statement can be assembled for provision to the sponsor 22 or any one of his co-recipients.

1. An apparatus for collecting and analysing survey data, said apparatus comprising:
collection means for collecting survey data;
storage means for storing the survey data as a plurality of selectable statements in a plurality of sets;
association means to associate, with each statement in each set, a score in one or more dimensions;
combination means to accept that statement which is selected in each set as the result for that set and to accept the respective score in one or more dimensions as the score for that set as a combination;
processing means to process and aggregate the scores in one or more dimensions; and
graphical display means for displaying the processed and aggregated scores in one or more dimensions as the results of the survey.

2. An apparatus, according to claim 1, wherein said graphical display means is operative to display said processed and aggregated scores in one or more dimensions with at least one of:
a selectable number of represented dimensions;
a radius variation for a results cloud;
a selectable result cloud colouration;
a trend arrow added to a result cloud;
a trend arrow added to a result point;
a selectable number of axes, a selectable number of axes, at least one of said axes being a combination of result dimensions; and
a selectable origin.

3. An apparatus, according to claim 1, comprising automatic report generation means, operative automatically to prepare a report on the survey data.

4. An apparatus, according to claim 3, wherein said report generation means is operative to prepare said report by analysing the results from a survey group, using the analysis to place the results from the group into one of a plurality of categories, there being one set of report statements allocated to each category, and placing the selected set of report statements, appropriate to the category of the survey results, into a report.

5. An apparatus, according to claim 3, wherein said report generation means is operative to include in said report at least one of:
an analysis statement;
a diagnosis statement; and
an advice statement giving a recommendation.

6. An apparatus, according to claim 1, wherein said collection means is operative to gather the survey data from at least one of:
electronic mail;
verbal instruction;
telephone message;
regular mail;
forms;
the Internet, an Intranet, and a digital television service.

7. A method for collecting and analysing survey data, said method including the steps of:
collecting survey data;
storing a plurality of selectable statements in a plurality of sets;
associating, with each statement in each set, a score in one or more dimensions;
accepting that statement which is selected in each set as the result for that set and
accepting the score in one or more dimensions as the score for that set;
processing and aggregating the score in one or more dimensions; and
graphically displaying the processed and aggregated scores in one or more dimensions as the results of the survey.

8. A method, according to claim 7, wherein said step of graphically displaying the processed and aggregated poly-dimensional scores includes the step of displaying at least one of:
a selectable number of represented dimensions;
a radius variation for a results cloud;
a selectable result cloud colouration;
a trend arrow added to a result cloud;
a trend arrow added to a result point;
a selectable number of axes;
a selectable number of axes, at least one of said axes being a combination of result dimensions; and
a selectable origin.

9. A method, according to claim 7, including the step of automatically generating a report on the survey data.

10. A method, according to claim 9, wherein step of automatically generating a report on the survey data comprises the steps of:
preparing the report by analysing the results from a survey group;
using the analysis to place the results from the group into one of a plurality of categories, there being one set of report statements allocated to each category; and
placing the selected set of report statements, appropriate to the category of the survey results, into a report.

11. A method, according to claim 9, wherein said step of automatically generating a report on the survey data includes the step of providing in said report at least one of:
an analysis statement;
a diagnosis statement; and
an advice statement giving a recommendation.

12. (canceled)

13. An analysis apparatus for analysing survey data, where the survey data comprises a plurality of selectable statements, each statement having associated therewith a score in one or more dimensions relating to a plurality of result dimensions, said analysis apparatus comprising: a result statement store for storing a result statement fragment for each of a plurality of ranges for each of the result dimensions; processing means to process and aggregate the scores for each result dimension; retrieval means operative, for each result dimension, to retrieve the appropriate result statement fragment for the processed and aggregated score for that result dimension; and conjunctive means to assemble the plurality of result statement fragments into one or more result statements, comprehensible in written language.

14. An apparatus, according to claim 13, operative to provide input to graphical display means, operative to display said poly dimensional scores with at least one of:
a selectable number of represented dimensions;
a radius variation for a results cloud;
a selectable result cloud colouration;
a trend arrow added to a result cloud;
a trend arrow added to a result point;
a selectable number of axes;
a selectable number of axes, at least one of said axes being a combination of result dimensions; and
a selectable origin.

15. An apparatus, according to claim 14, comprising report generation means operative to prepare a report by using the analysis of the survey data to place the results from the group into one of a plurality of categories, there being one set of report statements allocated to each category, and placing the selected set of report statements, appropriate to the category of the survey results, into a report.

16. An apparatus, according to claim 15, wherein said report generation means is operative to include in said report at least one of: an analysis statement; a diagnosis statement; and an advice statement giving a recommendation.

17. An apparatus, according to claim 13, comprising collection means, operative to gather the survey data from at least one of: electronic mail; verbal instruction; telephone message; regular mail; forms; the Internet, an Intranet, and a digital television service.

18. A method for analysing survey data, where said survey data comprises a plurality of selectable statements, each statement having associated therewith a score in one or more dimensions, said method including the steps of:
storing, in a result statement store, a result statement fragment for each of a plurality of ranges for each of the result dimensions;
processing and aggregating the scores for the selected statements for each result dimension;
retrieving, for each result dimension, the appropriate result statement fragment for the processed and aggregated score for that result dimension; and
assembling the plurality of result statement fragments into one or more result statements, comprehensible in written language.

19. A method, according to claim 18, including the step of graphically displaying the poly-dimensional scores, wherein said step of graphically displaying the poly-dimensional scores includes the step of displaying at least one of: a selectable number of represented dimensions; a radius variation for a results cloud; a selectable result cloud colouration; a trend arrow added to a result cloud; a trend arrow added to a result point; a selectable number of axes; a selectable number of axes, at least one of said axes being a combination of result dimensions; and a selectable origin.

20. A method, according to claim 19, including the step of automatically generating a report on the survey data, comprising the steps of:
preparing the report by analysing the results from a survey group;
using the analysis to place the results from the group into one of a plurality of categories, there being one set of report statements allocated to each category; and
placing the selected set of report statements, appropriate to the category of the survey results, into a report.

21. A method, according to claim 20, wherein said step of automatically generating a report on the survey data includes the step of providing in said report at least one of: an analysis statement; a diagnosis statement; and an advice statement giving a recommendation.

22-24. (canceled)
